(19) United States
(12) Patent Application Publication
(10) Pub. No.: US 2015/0363949 A1
(43) Pub. Date: Dec. 17, 2015

(54) STADIUM VIEW VISUALIZATION

(71) Applicant: Informatica Corporation, Redmond City, CA (US)

(72) Inventor: Atul Arvind Manohar, Bangalore (IN)

(21) Appl. No.: 14/302,668

(22) Filed: Jun. 12, 2014

(51) Int. Cl. G06T 11/20; H04L 12/26

(52) U.S. Cl. CPC G06T 11/20; H04L 43/06

(57) ABSTRACT

A computer system and computer implemented method provide a stadium view visualization of large sets of data elements, such as network configurations. Each element has a type and is represented in the visualization by an object. The stadium view includes a plurality of frames, with each frame containing objects representing elements of a corresponding type. On receiving selection of an object, relationship data for the corresponding element is retrieved, and a visual attribute of objects that represent elements related to the corresponding element is modified. The modification of the visual attribute visually distinguishes those objects representing elements related to the corresponding element from objects representing elements that are not related to the corresponding element.

### BACKGROUND

1. Technical Field

The subject matter described herein relates generally to data visualization, and in particular, to visualizing complex, multi-layered, and changing relationships between elements in a network.

2. Background Information

Modern day computer networks include numerous different types of elements, and often a large number of each type. The relationships between such elements are complex, multi-layered, and change on a regular basis. Typically, such relationships are represented using one of many variants of a graph, which represents each element in the network as node in the graph with some kind of geometric shape and each relationship as a line connecting the corresponding nodes. For networks with a large number of entities and relationships, graphs rapidly become confusing, and even unintelligible. As a result, for a network administrator, the task of identifying a particular element to take quick corrective action can be like hunting for a needle in a haystack.

Visualizing a computer network is one example of a wider problem with the presentation of complex relationships in large systems. Other examples of systems that may have complex, multi-layered and/or regularly changing relationships include social networks, product catalogs, business structures, and the like. In each of these cases, presenting the whole system using a typical graph can result in a chaotic, overwhelming morass of visual elements that obfuscates the meaning, rather than enlightens the user. It is possible that by removing elements, a small sub-set of data can be meaningfully inspected, but this comes at the expense of losing context, and unexpected relationships may be missed entirely.

### SUMMARY

A method and system enable a stadium view visualization of a large network of inter-related elements. The stadium view visualization includes a frames portion and a toolbar portion. The frames portion comprises a plurality of frames, each frame corresponding to a type of element in the network to be visualized. For example, different frames can represent gateways, hosts, transports, topic resolution domains (TRDs), applications, databases, storage devices, or the like. Within each frame objects representing the elements of the corresponding type are displayed as graphical elements. The selection of an object in one frame results in other objects in other frames that are related to the selected object having a visually distinguishable attribute applied to them (e.g., by changing the color of the object). For example, the selection of an object representing a specific gateway in a gateway frame causes the application objects TRDs that send data packets via the specific gateway be distinguished in corresponding application and TRD frames. Thus, the current relationships in the network can be efficiently explored by the user.

The toolbar portion provides functionality for the user to search by keyword and/or apply filters to the objects displayed in the frames portion. In a further aspect, the user may visually distinguish and sort the objects based on the operational status corresponding to the objects, for example whether the objects are operating correctly, are exhibiting occasional errors (e.g., occasional dropped packets), have completely failed, or the like.

### BRIEF DESCRIPTION OF THE DRAWINGS

FIG. 1 is a high-level block diagram illustrating a networked computing environment suitable for implementing a stadium view visualization, according to one embodiment.

FIG. 2 is a high-level block diagram illustrating one embodiment of the administrator system depicted in FIG. 1.

FIG. 3 is a high-level block diagram of the components of a computing system suitable for use in the networked environment depicted in FIG. 1, according to one embodiment.

FIG. 4 is a flowchart illustrating a method of using a stadium view visualization to indicate objects that are related to a selected object, according to one embodiment.

FIG. 5 is a flowchart illustrating a method of filtering objects in a stadium view visualization based on a selected object, according to one embodiment.

FIG. 6 is a flowchart illustrating a method of filtering objects in a stadium view visualization based on a selected state, according to one embodiment.

FIG. 7 is a flowchart illustrating a method of identifying objects in a stadium view visualization that are related to a particular topic, according to one embodiment.

FIGS. 8A-F illustrate frames of a stadium view visualization with various levels of detail provided based on the number of objects included therein, according to one embodiment.

FIGS. 9A-C illustrate a stadium view visualization of a computer network at various stages of the method of FIG. 4, according to one embodiment.

FIGS. 10A-C illustrate a stadium view visualization of a computer network as filters based on selected objects are applied, according to one embodiment.

FIGS. 11A-C illustrate a stadium view visualization of a computer network at various stages of the method of FIG. 6, according to one embodiment.

FIGS. 12A-B illustrate a stadium view visualization of a computer network at various stages of the method of FIG. 7, according to one embodiment.

### DETAILED DESCRIPTION

The stadium view visualization leverages the ability to quickly identify visual distinctions (such as differences in color) between objects, so as to enable a user to explore the relationships between a large number of elements that are divided into multiple groups. The stadium view visualization is inspired by the insight that in a physical stadium one can readily identify different groups (e.g., teams) of players and fans in a stadium based on their jersey colors, even if we cannot recognize them individually. The stadium view visualization makes use of this ability to quickly group objects based on visually similar distinguishing attributes. In one embodiment, five to ten groups can be simultaneously visualized, with each group having up to 100,000 elements. The stadium view visualization represents elements as objects in the visualization, such as rectangles in a grid. Objects corresponding to elements that meet a set of criteria, such as being related to a selected element, being in a particular state, being associated with a particular topic, or the like are visually distinguished by applying a common visual attribute. For example, on user-selection of an element, objects that are related to the selected element may be visually distinguished by adding or modifying one or more of: color, fill texture, outline, brightness, size, or shape. Thus, in the same way members of a sports team can be identified visually within a stadium by appearing on the field and in uniform, elements within the stadium view visualization can be identified as being in a common group by being displayed with a common set of visual features.

The Figures (FIGS.) and the following description describe certain embodiments in which the stadium view visualization is applied to a computer network by way of illustration only. One of skill in the art will recognize from the following description that the stadium view visualization can be applied to other computer based representations of inter-related elements, and that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

### System Configuration

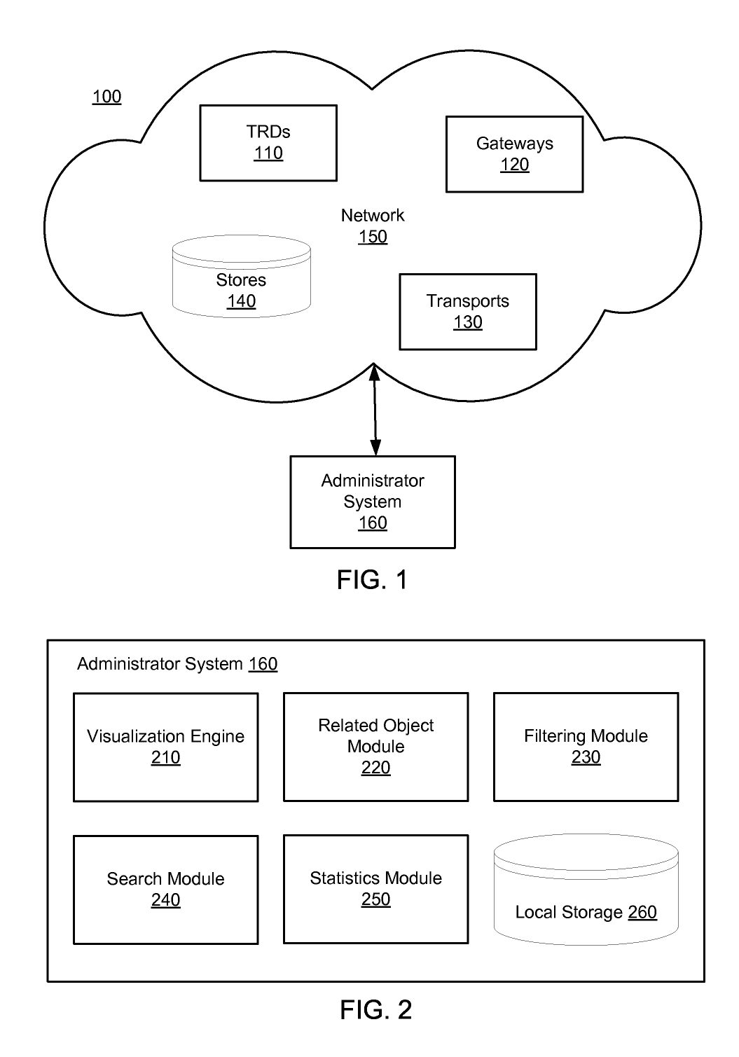

FIG. 1 illustrates one embodiment of a networked computing environment 100 suitable for implementing a stadium view visualization. The networked computing environment 100 contains numerous elements to be included in the stadium view visualization, including a plurality of topic resolution domains (TRDs) 110, a plurality of gateways 120, a plurality of transports 130, a plurality of stores 140, and an administrator system 160, all connected via a network 150. Elements can be physical (e.g., gateways, hosts, etc.) or virtual (e.g., TRDs, application instances, etc.). The network 150 is typically a large enterprise IP based network, but can be any network, including but not limited to any combination of a LAN, MAN, WAN, mobile, wired, wireless, public, private, or virtual private network. In other embodiments, the networked computing environment contains different and/or additional types of elements that are included in the stadium view visualization. For example, in one embodiment, the elements of the networked computing environment 100 to be visualized further includes hosts, application instances, and system notifications. In addition, the functions may be distributed among the elements in a different manner than described herein.

The TRDs 110, gateways 120, transports 130, and stores 140 provide functionality to the users of the network 150. The TRDs 110 are logical entities that represent conceptually related groups of elements within the networked computing environment 100. In one embodiment, all of the elements within a TRD 110 communicate with each other, and are thus considered related. For example, if the networked computing environment 100 provides stock trading tools, it may contain a TRD 110 for each type of industry for which stocks are tradable within the environment. Each computing device within the network that contributes to the provision of tools for trading stock in a particular type of industry is therefore related to the TRD 110 corresponding to that type of industry.

The gateways 120 route data packages between the different TRDs 110 that make up the network 150. If elements from different TRDs 110 need to communicate, the messages are routed through one or more gateways 120. Thus, the gateways 120 act as an interface between two or more TRDs 110. For example, if a stock trading application providing stock trading tools within a first TRD 110 (e.g., a TRD for the banking sector) wishes to obtain share price information for a related industry (e.g., insurance), then the application sends a request for this information to a second application within a second TRD that corresponds to the related industry. The request is routed through a gateway 150 that manages communication between the two TRDs 100. In this case, the gateway is considered to be related to both TRDs. In one embodiment, a gateway 120 is considered related to the TRDs 110 it connects as well as the elements (e.g., stores 140, applications, etc.) included in those TRDs.

The transports 130 are the communication channels through which messages are exchanged between source elements and receiving elements. Possible source and receiving elements include stores 140, gateways 120, and applications (not shown). For example, if two applications executing within a particular TRD 110 exchange data, this data is routed between the applications using a particular transport 130, such as an Ethernet connection. In this case, the particular transport 130 is considered to be related to both applications. In one embodiment, a transport is considered related to all of the elements that it relays messages between.

The stores 140 provide temporary storage for messages while they are in transit to ensure the messages are delivered. A store 140 typically persist messages until they have been delivered to the desired receivers, those messages for which delivery initially fails to be re-sent. For example, if a source application generates a message to be sent to a destination application, the message is added to a store 140 and delivery attempted. The message remains in the store 140 until successful delivery to the destination application is confirmed. In this case, the store 140 is considered to be related to both the source application and the destination application. In one embodiment, a store 140 is considered to be related to all source and receiving elements for which it stores messages pending confirmation of successful delivery.

The administrator system 160 provides tools, including the stadium view visualization, to a user (e.g., a network administrator) to facilitate network monitoring and troubleshooting. By using the stadium view visualization, the user can quickly and intuitively identify problems in the network 150 and take appropriate corrective action, such as reallocating resources, redirecting network traffic to improve load balancing, and/or replacing faulty components. In one embodiment, the administrator system 160 identifies each element in the network 150 with an element identifier that uniquely identifies the corresponding element. In various embodiments, the stadium view visualization can be used in conjunction with a network administration tool that can be used to configure the various elements of the network and monitor their performance.

FIG. 2 illustrates one embodiment of an administrator system 160 configured to provide a stadium view visualization of the elements in a networked computing environment 100 and the relationships between those elements. The administration system 160 includes local storage 260, a visualization engine 210, a related object module 220, a filtering module 230, a search module 240, and a statistics module 250. In other embodiments, the administrator system 160 contains different and/or additional components. In addition, the functions may be distributed among the components in a different manner than described herein.

The local storage 260 comprises one or more non-transitory computer-readable media and is configured to store data used by the administrator system 160 in providing the stadium view visualization, and is one means for performing this function. The data stored by the local storage 260 includes but is not limited to configuration information of the elements of the network, status information of the elements of the network, performance statistics of the elements of the network, and user preferences. In one embodiment, the related object module 220 maintains a database of relationships between elements in the local storage 260, representing each object type in a separate table, with each object's database record including references or links to its related objects; other approaches to storing the relationships can be used as well. When an element is added to the network 150 or reconfigured, the related object module 260 updates the stored relationship data to indicate all elements that are related to the added or reconfigured element.

The specific meaning of a pair of elements being related is dependent on the types of the individual elements in the pair. For example, a TRD 110 might have a “virtual container” type of relationship with each of the elements included within it, indicating that the TRD is a logical entity binding all of those elements. As another example, a gateway 120 connecting two elements in different TRDs 110 might have a “connector” type relationship with both the TRDs and the individual elements within each TRD. As yet another example, a transport 130 that routes messages from a first application to a second application might have a “connector” type relationship with both applications. Although these relationships are described as being of a particular type for illustrative purpose, the database does not necessarily store information about the type of each relationship.

As a result of the various interactions that elements have with each other within the networked computing environment 100, any given element is likely to be associated with multiple relationships of multiple types. Further, over time these relationships will change as elements are added and removed, load balancing actions are implemented, configuration changes are made, and the like. For example, a given TRD 110 may initially be related to a plurality of stores 140 that are within the TRD, a gateway 120 that connects a pair of elements within the TRD, and a plurality of transports 130 that relay traffic both between elements within the TRD and to elements within other TRDs. At a later point in time, activity relating to the TRD 110 picks up (e.g., if the TRD is part of a stock trading system and the industry to which the TRD corresponds becomes “hot”) and as a result, a higher capacity gateway 120 and additional transports 130 are added to the TRD, changing the relationships associated with the TRD.

In one embodiment, each relationship has a lifetime associated with it which is reset each time the relationship is used. If a relationship is not used for a period of time equaling the lifetime, the relationship is removed from the relationships database. For example, a gateway 150 that routes a message between a pair of TRDs 110 may be considered relate to those TRDs for a 24 hour period after the message is routed. If the gateway 150 routes no further messages between the TRDs 110 in that period, the relationships between each TRD and the gateway are considered to have expired (assuming the gateway does not route additional messages between one or both TRDs and alternate destinations). In other embodiments, other time scales and methods for determining when a relationship has expired are used.

The visualization engine 210 receives information identifying the elements in the network and the corresponding types (TRDs 110, stores 140, etc.) and generates the stadium view visualization for display to the user (e.g., on a display of the administrator system 160), and is one means for performing this function. The visualization engine may retrieve the information from local storage 260 and/or by directly inspecting the network 150 (e.g., by broadcasting a request for elements to identify themselves). In one embodiment, the visualization engine 210 generates a stadium view visualization that comprises a plurality of non-overlapping frames, each frame corresponding to one of the types of network element. Each frame includes one or more non-overlapping objects (e.g., rectangles in a grid), with each object representing an instance of an element of the type corresponding to the frame. In other embodiments, different objects are used for the elements and/or the objects are arranged in other manners. For example, each element may be represented by a circle, and all of the elements may be presented in a single frame, rather than being grouped into different frames by type.

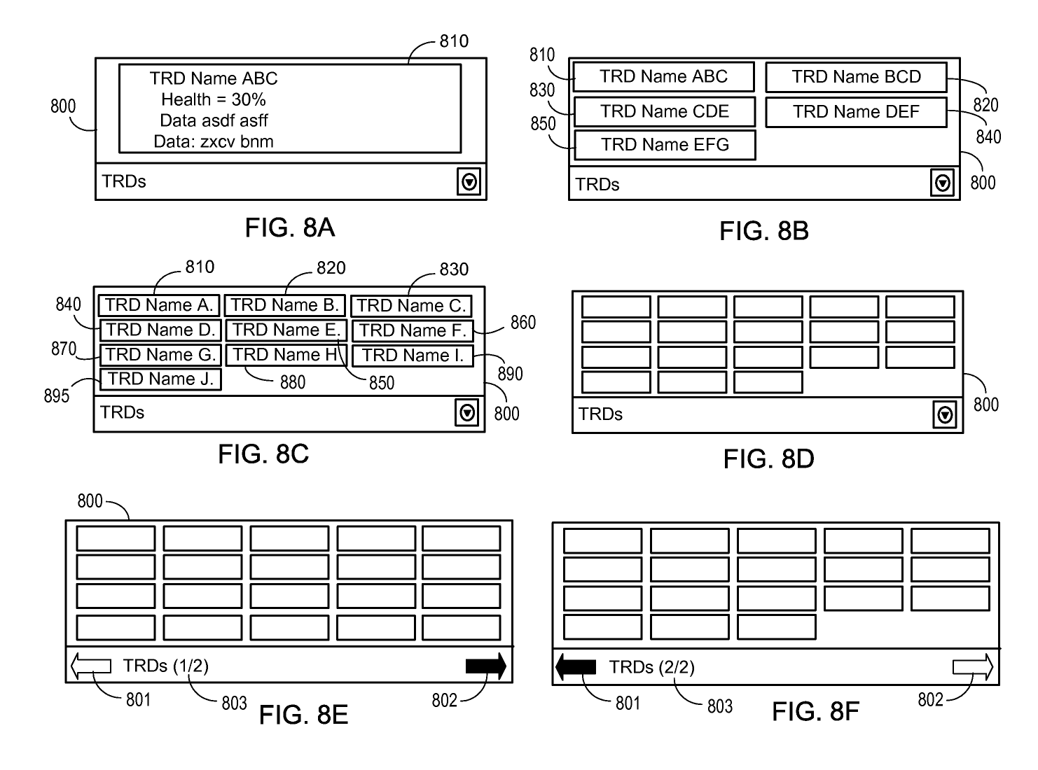

FIGS. 8A-E illustrate the display of a single frame (which in this case shows TRDs 110) when the frame contains different numbers of objects, according to one embodiment. The visualization engine 210 determines, from the amount of display area available in the frame 800 and the number of objects to be displayed, the size and content of each object, generally reducing the size and information content of each object as the number of objects increases. In FIG. 8A, only a single object 810 representing a TRD 110 is displayed in the frame 800. As there is sufficient available space in the frame 810, the details of the object 810 are displayed such as the TRD's name, status (“health level”), and other information about the TRD 110.

In FIG. 8B, the frame 800 now contains objects 810-850 corresponding to five TRDs 110. As a result, each individual object 810-850 is smaller than in FIG. 8A, and contains just the name of the corresponding TRD 110. In FIG. 8C, the frame 810 includes ten TRD objects 810-895 and, as a result, the full names can no longer be displayed in the space available. The objects are therefore presented with a truncated version of the corresponding element's name. Similarly, in FIG. 8D, with the inclusion of even more TRD objects, there is no longer space to display even the truncated names, and thus each TRD is represented by just the rectangular object, with no associated text. In FIG. 8E, the number of TRD objects in the frame 800 has increased yet further, and consequently, not all of the objects can be displayed in the frame at one time, even using just the plain rectangular representation. Thus, the TRD objects are split across multiple pages and scrolling arrows 801 and 802 provided, along with an indication of the current page and the total number of pages 803, which enable the user to move between the different pages. FIG. 8F shows the second page of TRD objects that would be displayed if a user clicked the “next page” arrow 802 in the frame 800 while in the status illustrated in FIG. 8E. The user could then return to the first page (as illustrated in FIG. 8E) by selecting the “previous page” arrow 801. At each level of detail, the user can request more detailed information about any given element (e.g., by right clicking on an object to open a menu and selecting a “details” option).

In one embodiment, the visualization engine 210 displays a frame including one object with the object's name and three additional lines of data, a frame with between two and six objects with the full object names with no additional lines of data, a frame with between seven and twelve objects with truncated element names, and frames with thirteen or more objects with just a rectangle to represent each element.

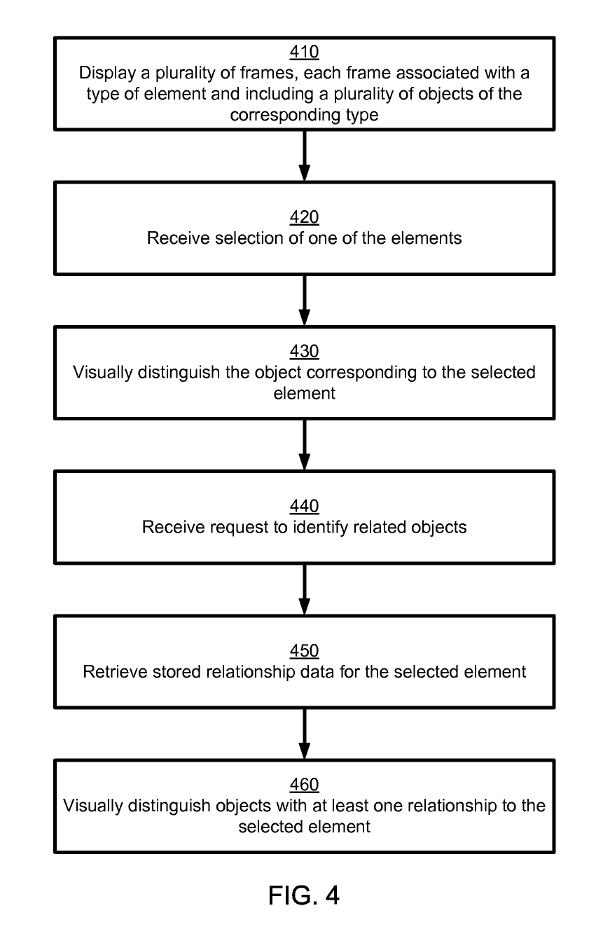

Referring back to FIG. 2, the related object module 220 provides the visualization engine 210 with information about the relationships between different elements in the network 150 to enable such relationships to be visualized on demand, and is one means for performing this function. In response to receiving an identifier of a selected element, the related object module 220 identifies the other elements in the network 150 that have at least one relationship with the selected element, as determined from the relationship data in the relationships database stored in local storage 260. Thus, when provided with an element identifier, the related object module 220 can quickly identify those elements that are related to the identified element by querying the database. For example, if a user selects a store 140, the related object module 220 can identify the specific gateway through which the store's sub-network can be accessed, the plurality of transports 130 used to transfer data to and from the store, and the TRD 110 associated with the store. An exemplary method of displaying elements related to a selected element is described below, with reference to FIG. 4.

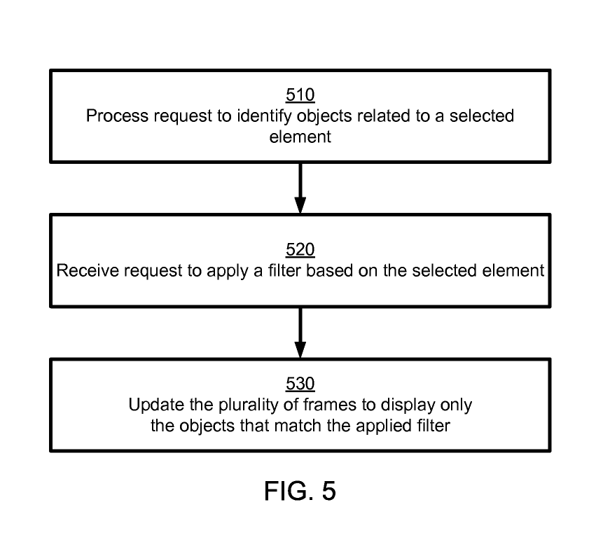

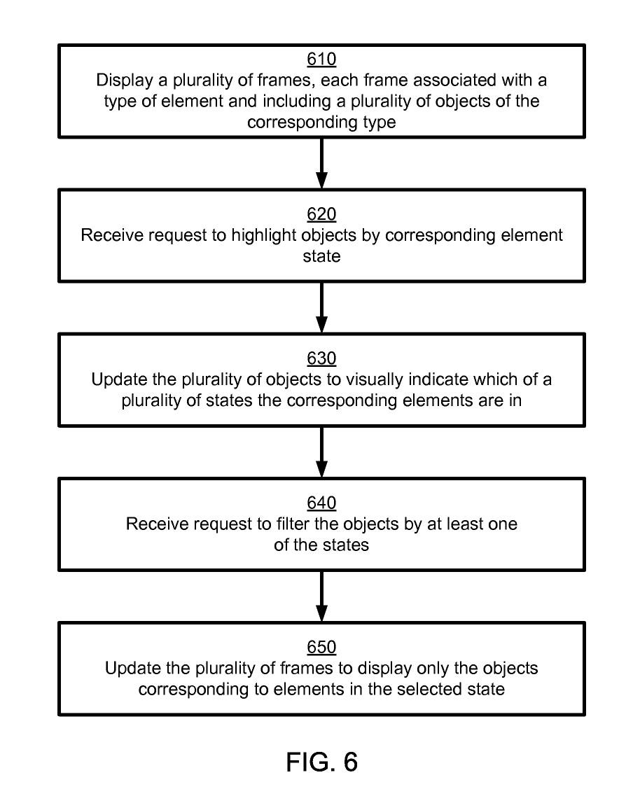

The filtering module 230 applies one or more filters to the objects in the stadium view visualization to identify those that should be displayed and those that should be hidden from view. In one embodiment, the filtering module 230 receives one or more filter criteria based on user input. The filter criteria indicate the properties by which the objects should be filtered and include at least one of: relationship to an identified element, current element state, and relationship to a specified topic (e.g., the results of a topic search, as described below, with reference to the search module 240). Filter criteria may be applied iteratively. Thus, the user can add filter criteria one after another to home in on the particular element in the network 150 that is causing a problem. Exemplary methods of filtering the displayed elements in the stadium view visualization based on various filter criteria are described below, with reference to FIGS. 5 and 6.

The search module 240 identifies which objects are related to a topic or other search term. In one embodiment, in which the stadium view is implemented as part of a messaging system, each message is persisted in a store 140 along with metadata indicating one or more topics (e.g., a group within an enterprise from which the message originated, a project to which the message relates, and the like). For example, if the messaging system is used in online stock-trading, a receiver application (e.g., a trading application operated by a trader) might subscribe to receive the stock price for a particular company, such as “Informatica.” A transmitter application (e.g., an application operated by a stock market) regularly sends messages to the receiver application that include the stock price for Informatica. Each of these messages is persisted in a store 140 with metadata identifying that it relates to the topic “Informatica.” Thus, by searching based on the metadata, the entire corpus of messages can be filtered to identify just those relating to the Informatica stock price.

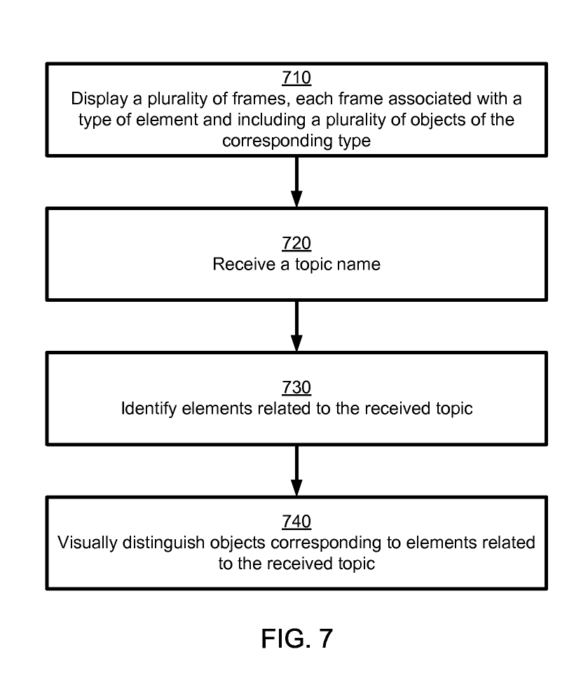

The relationships database includes an indication for each store 140 of all of the topics for which messages are persisted to that store. Thus, if an end user reports that expected messages of a particular topic are not being received, the network manager can perform a search on that topic and the search module 240 can identify which stores 140 should be considered during trouble shooting. The search module 240 can then also identify the elements of other types that contribute to delivery of messages from the identified stores 140, and thus identify all of the elements in the network 150 that are reasonable candidates to consider as the cause of the problem. The search module 240 then provides this information to the visualization engine 210, which can then apply a visually distinctive property to the corresponding objects in the stadium view visualization. Thus, the network manager can quickly narrow the search for the cause of the problem. An exemplary method for visually distinguishing objects that are related to a particular topic is described in greater detail below, with reference to FIG. 7.

The statistics module 250 monitors and records the performance of the elements in the network 150 (e.g., by writing performance statistics to a log file in local storage 260 at regular intervals) in order to assist the user in diagnosing problems. Although the statistics module 250 is described as being part of the administrator system 160, in some embodiments, some or all of the elements in the network 150 record their own performance statistics, and only provide them to the administrator system 160 on demand (e.g., using a system level API provided by the element). In general, various performance metrics of each element are monitored on an on-going basis and stored in log files, either at the administrator system 160 or locally, where they can be accessed and further processed by the statistics module 250. Thus, the statistics module 250 can provide a picture of how the element has been performing over time by presenting metrics such as datagrams sent per second, datagrams retransmitted per second, negative-acknowledgement characters (NAKs) received per second, NAKs shed per second, and the like. For example, if a given element has consistently been transmitting a certain number of datagrams per second, and that metric suddenly drops to a consistently lower value, it provides a strong indication that there is a problem that needs to be addressed, and that the problem is related to a change that occurred at the time the transmission rate dropped. In one embodiment, a monitoring agent and admin demon collects are correlates performance information to generate the performance metrics, and the statistics module 250 is presents the variation (or lack thereof) of each metric over time in a graph.

Collectively, the components of the administrator system 160 identify which objects should be displayed to the user, and what relationships exist between the displayed objects. The user interacts with the stadium view visualization generated by the visualization engine 210 to explore this data space. The stadium view visualization assists the user in identifying related elements by presenting the corresponding objects with visually distinguished attributes. The stadium view visualization also enables the user to iteratively apply filters based on the identified relationships to narrow the field of search when trying to identify a particular element, such as one that is causing network failures or other issues, based on selected relationships and/or object statuses.

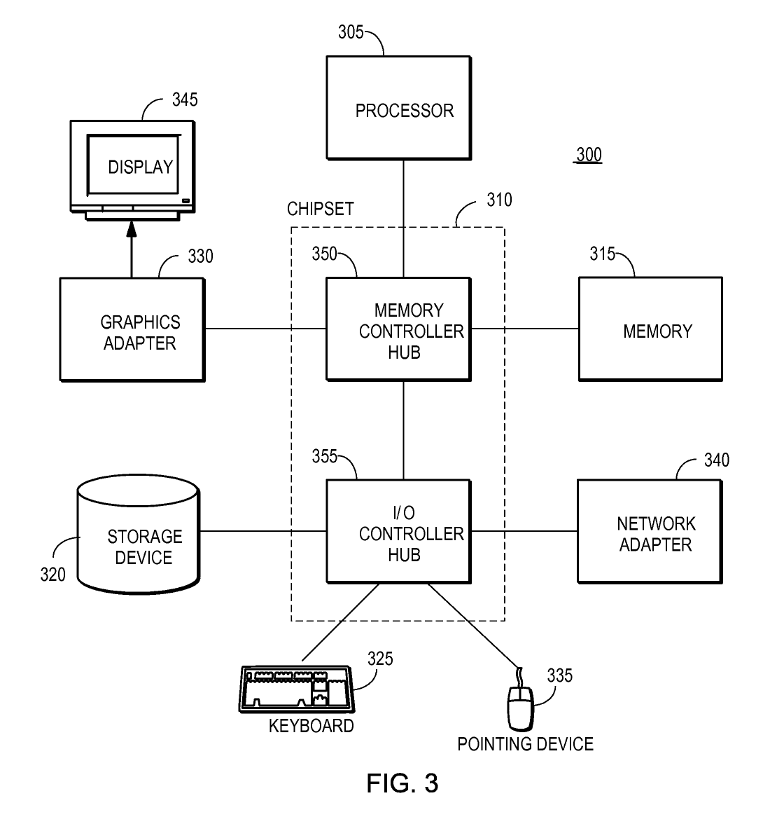

FIG. 3 is a high-level block diagram of the components of a computing system 300 suitable for use in the network environment 100, for example, as the administrator system 160 or a gateway 120, in accordance with one embodiment. Illustrated are at least one processor 305 coupled to a chipset 210. Also coupled to the chipset 310 are a memory 315, a storage device 320, a keyboard 325, a graphics adapter 330, a pointing device 335, and a network adapter 340. A display 345 is coupled to the graphics adapter 330. In one embodiment, the functionality of the chipset 310 is provided by a memory controller hub 350 and an I/O controller hub 355. In another embodiment, the memory 315 is coupled directly to the processor 305 instead of the chipset 310.

The storage device 320 is any non-transitory computer-readable storage medium, such as a hard drive, compact disk read-only memory (CD-ROM), DVD, or a solid-state memory device. The memory 315 holds instructions and data used by the processor 305. The pointing device 335 may be a mouse, track ball, or other type of pointing device, and is used in combination with the keyboard 325 to input data into the computer 300. The graphics adapter 330 displays images and other information on the display 345. The network adapter 340 couples the computer 300 to a network (e.g., the network 150 of FIG. 1).

As is known in the art, a computer 300 can have different and/or other components than those shown in FIG. 3. In addition, the computer 300 can lack certain illustrated components. For example, a computer 300 acting as a gateway 140 may lack a keyboard 325, pointing device 335, graphics adapter 330, and/or display 345. As another example, a computer 300 configured to display the stadium view visualization may be a tablet or smartphone with a touch screen interface and thus lack a keyboard 325 and pointing device 335. Moreover, the storage device 320 can be local and/or remote from the computer 300 (such as one or more of the stores 140).

As is known in the art, the computer 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 320, loaded into the memory 315, and executed by the processor 305.

Embodiments of the physical components described herein can include other and/or different modules than the ones described here. In addition, the functionality attributed to the modules can be performed by other or different modules in other embodiments. Moreover, this description occasionally omits the term “module” for purposes of clarity and convenience.

### Exemplary Methods

The various methods described below are representative of the functionality provided by the stadium view visualization. Although these methods are presented as discrete tasks, in typical use cases a user may often apply two or more of the methods when exploring the data space represented by the visualization. For example, when searching for a network element that is causing network failures, the user might first apply a filter such that only the objects corresponding to elements with issues are displayed (see FIG. 6), and then search for a topic known to be associated with the failure, which results in objects related to the topic being highlighted (see FIG. 7).

FIG. 4 illustrates an exemplary method of providing a visual indication of objects that are related to a selected object, according to one embodiment. The steps of FIG. 4 are illustrated from the perspective of various components of the administrator system 160 performing the method. However, some or all of the steps may be performed by other entities and/or components. In addition, some embodiments may perform the steps in parallel, perform the steps in different orders, or perform different steps.

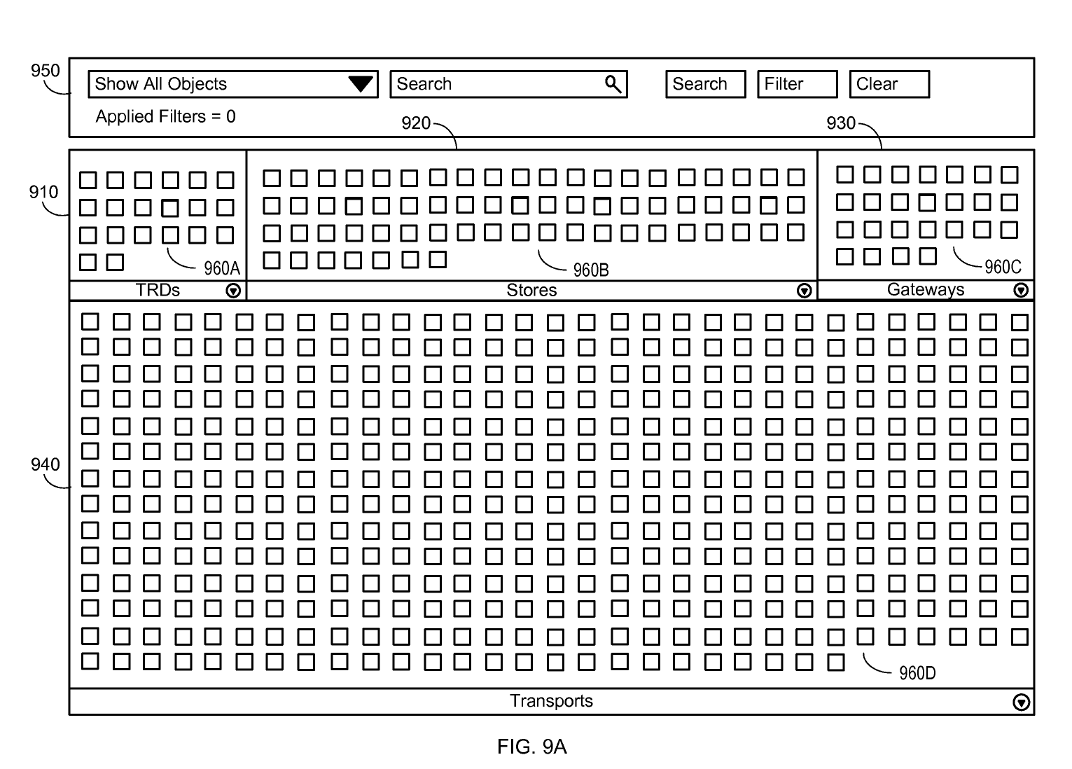

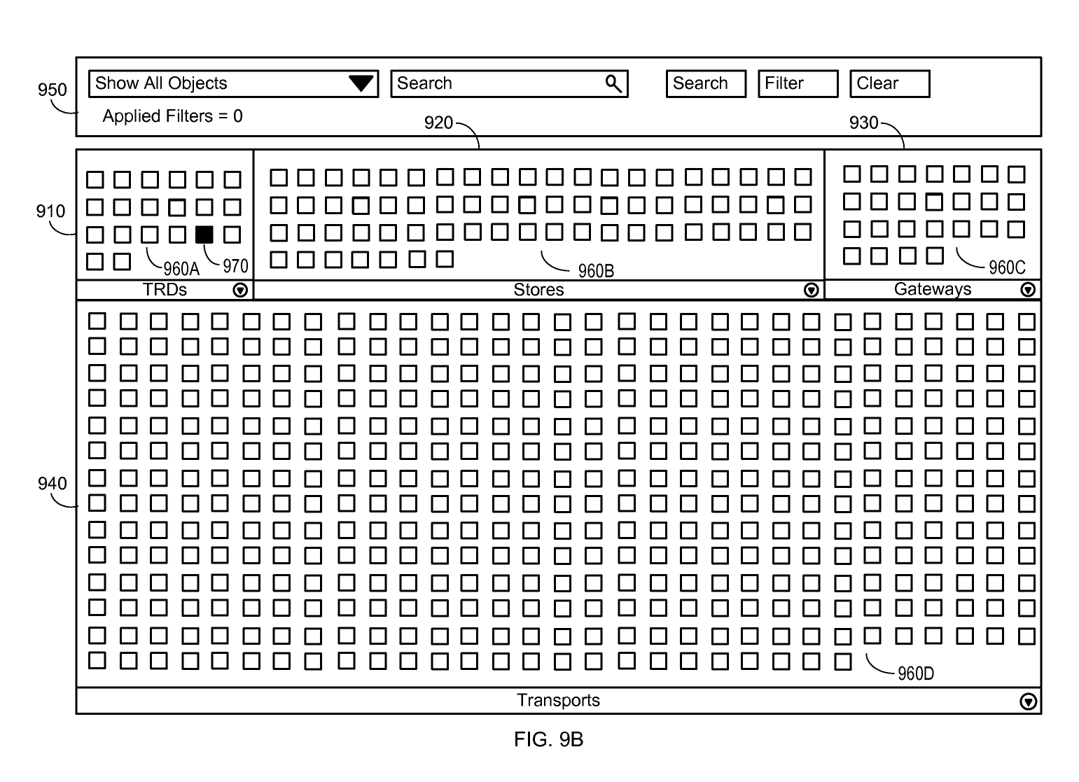

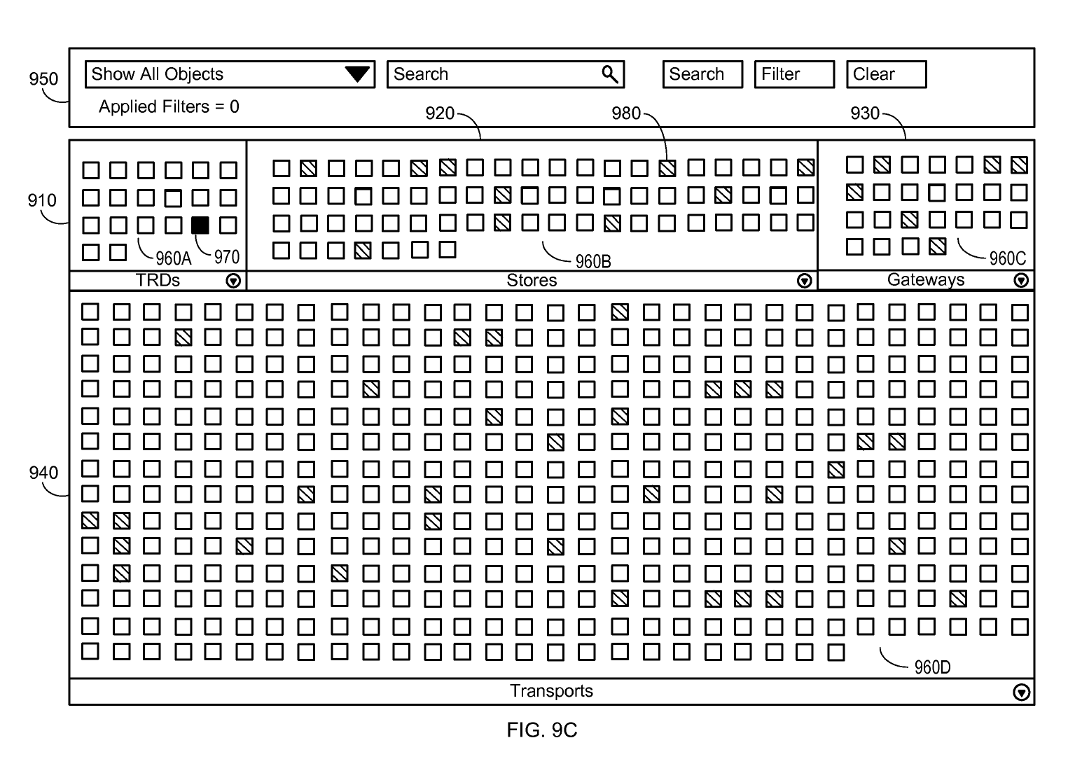

At 410, the visualization engine 210 displays a plurality of frames. Each frame is associated with a type of element in the network, and includes a plurality of objects of the corresponding type. FIG. 9A illustrates the appearance at this step in the method of the stadium view visualization as applied to the networked environment 100, according to one embodiment. The visualization includes four frames, a frame 910 displaying TRD objects, a frame 920 displaying store objects, a frame 930 displaying gateway objects, and a frame 940 displaying transport objects. The visualization also includes a toolbar portion 950 that provides controls enabling the user to search and filter the displayed objects. Use of the toolbar will be described in greater detail below with reference to various exemplary use cases.

In the embodiment shown, each frame contains a grid of boxes 960A-D (objects), with each box being an object that represents a system element of the corresponding type. Each box in the grid 960A corresponds to a TRD 110, each box in the grid 960B corresponds to a store 140, each box in the grid 960C corresponds to a gateway 120, and each box in the grid 960D corresponds to a transport 130. As described previously with reference to FIG. 8, the amount of information contained in each box depends on the number of boxes displayed in the frame and the size of the frame. At this stage, as the entire network environment 100 is being visualized, there are a large number of objects in each frame, and thus just the boxes are displayed, with no additional information. Note that the objects are non-overlapping and regularly arranged, making it easy for the user to distinguish between and identify each object. The user may request additional information about any given element, for example by right clicking on the corresponding object and selecting a “more information” option from a resulting pop-up menu, which causes the statistics module 250 to provide information about the performance of the element.

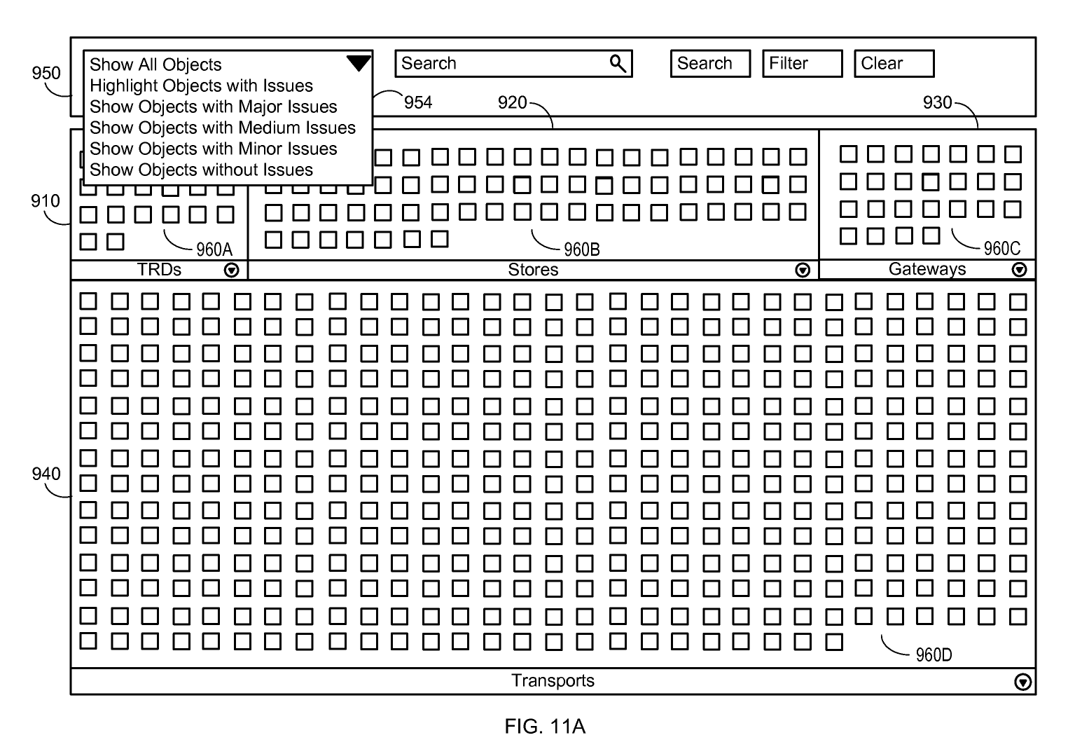

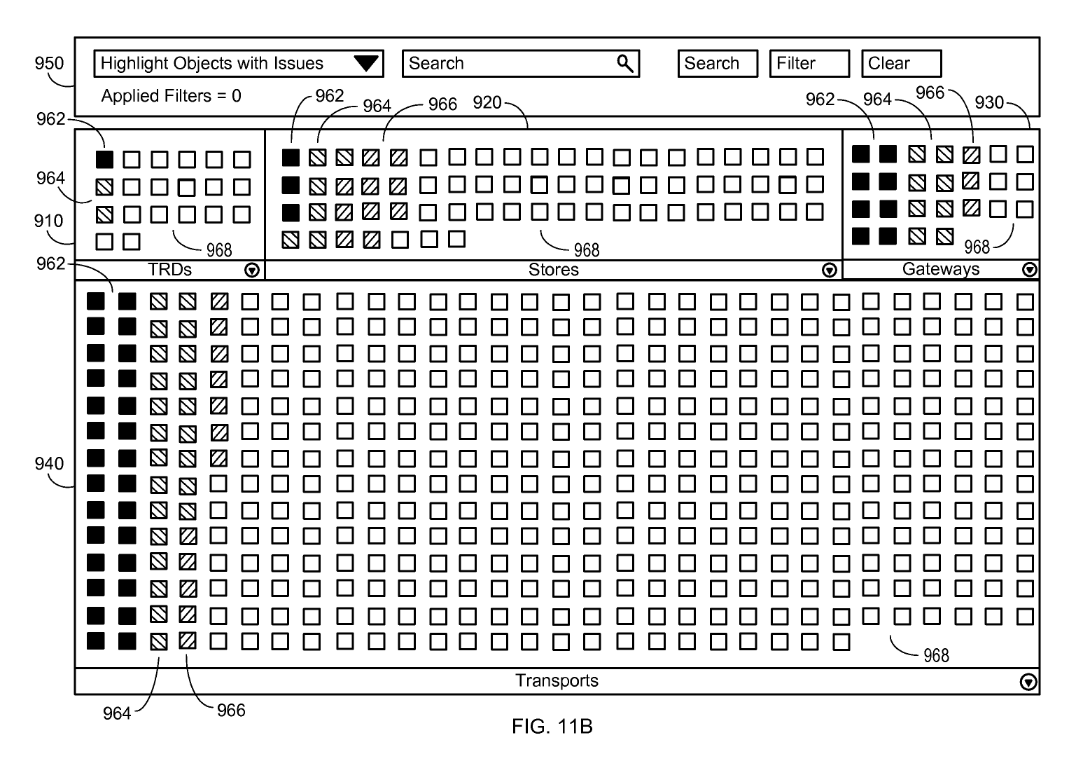

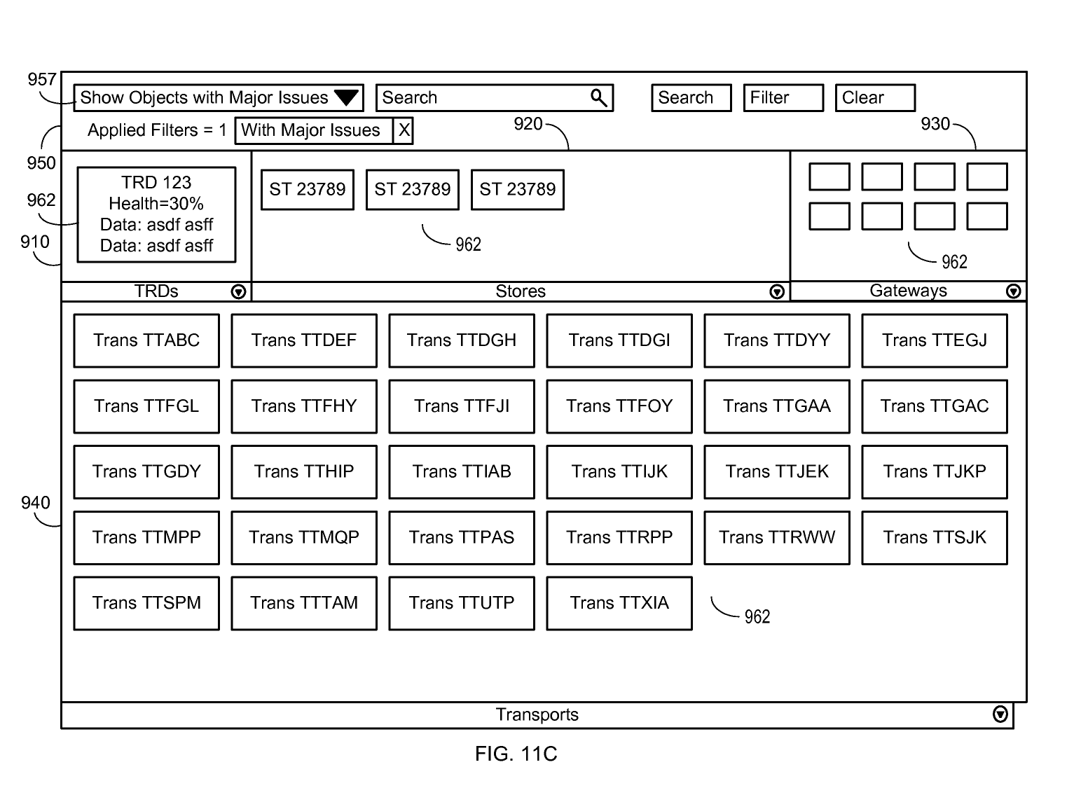

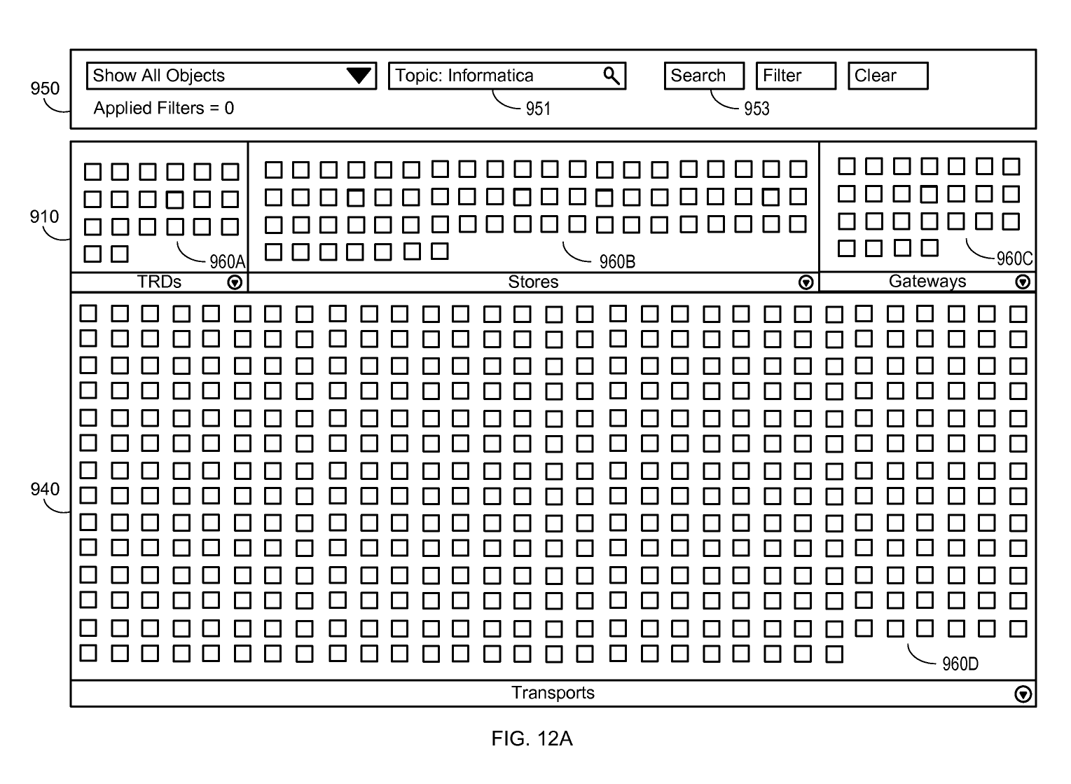

In some embodiments, the object types included in each frame can be customized by the user. Frames may also be individually customized to show all objects of the selected type, or include a filter (e.g., as provided by the filter module 230) such that it displays just those objects that have a specific status, e.g., have specific operational issues. Thus, a user could have one frame showing all transports, and another showing just those transports that have a particular operational status. For example, FIGS. 11A-C illustrate an embodiment which defines operational statuses in terms of severity of issues. In one embodiment, objects can be in one of three operational states: 1) major issues, 2) minor issues, and 3) healthy. The criteria used to identify an object's state can vary based on the type of object and may be configurable by the system administrator. For example, for a transport 130, the major issue state may be defined as the transport not being live, the minor issue state might be defined as the transport experiencing message losses above a threshold value, and the healthy state may be defined as the transport experiencing message losses below the threshold value. Similarly, for a store 140, the major issue state may be defined as the store being unresponsive, the minor issue state might be defined as the store failing to persist some messages, and the healthy state may be defined as the store successfully persisting all messages it receives. Such customization enables the user to efficiently and intuitively explore the data space and tailor the visualization to the particular task being undertaken.

Referring back to FIG. 4, the related object module 220 receives 420 an identifier of a selected one of the elements. The selection is typically provided by the user (e.g., by clicking on the corresponding object in the visualization) but may also be provided in other manners. The visualization engine 210 updates 430 the stadium view visualization to apply a visually distinguishable attribute to the object corresponding to the selected element. FIG. 9B illustrates how the visualization engine 210 updates the stadium view visualization in response to the selection of an object 970, in this case corresponding to one of the TRDs, in accordance with one embodiment. Notice that a black fill has been applied to the object 970 representing the selected TRD in the visualization, and thus the object is visually distinguished (and easily identifiable) over the other objects. In FIG. 9B, the attribute of the selected object 970 that is modified is the fill color (from white to black), but visual attribute of an object may be modified to distinguish the selected object over the other objects in the visualization, such as the brightness, outline style, size, shape, fill texture, and the like.

Referring again to FIG. 4, at 440, the related object module 220 receives a request to identify objects that are related to the selected element. The request is typically initiated by the user (e.g., by double clicking on the object corresponding to the element to be selected) but may also be initiated in other manners. The related object module 220 retrieves 450 relationship data for the selected element (e.g., a database table identifying all objects related to the selected object, in local storage 260). The relationship data identifies relationships that the selected element has with other elements in the networked environment 100. In one embodiment, the system provides a user interface control to enable the user to request that a visually distinguishable attribute is applied to all objects related to a particular element without previously selecting the element (e.g., by double clicking on an object in the visualization without previously selecting it).

Based on the relationship data, the visualization engine 210 updates 460 the stadium view visualization to apply a visually distinguishable attribute to the objects (e.g., object 980) that are related to the element corresponding to the selected object 970. FIG. 9C illustrates how the visualization engine 210 updates the stadium view visualization in response to a request to indicate objects that are related to a selected element corresponding to the selected object 970, in accordance with one embodiment. Notice that the objects such as object 980 that correspond to various transports, stores, and gateways are now visually distinguished over the other objects. Further notice that, unlike in conventional graph-based network representations, there are no lines joining related elements, resulting in a less cluttered visual representation of the network 150. The visually distinguished objects are those corresponding to elements that are related to the selected TRD, represented by object 970. In FIG. 9C, the related objects are visually distinguished by changing the value of a fill texture attribute from “plain” to “diagonal lines,” but any visual attribute may be applied to distinguish the related objects from the other objects in the stadium view visualization, such as fill color, brightness, outline style, size, shape, and the like. In another embodiment, the visually distinguishable attribute applied to the related object is the same as that applied to the selected object 970.

FIG. 5 illustrates an exemplary method for applying filters based on a selected element, in accordance with one embodiment. The steps of FIG. 5 are illustrated from the perspective of various components of the administrator system 160 performing the method. However, some or all of the steps may be performed by other entities and/or components. In addition, some embodiments may perform the steps in parallel, perform the steps in different orders, or perform different steps.

At 510, the administrator system 160 processes a request to identify objects that are related to an element. For example, the method described above with reference to FIG. 4 may be performed, resulting in the stadium view visualization shown in FIG. 9C. At 520, the filtering module receives a request to filter the objects displayed in the stadium view visualization based on the selected element. In the embodiment shown in FIGS. 9A-C, the user applies a filter by selecting the object corresponding to the element to be filtered by and then clicking on a filter button 955 in the toolbar 950. As the set of related objects has already been identified in order to apply the visually distinguishable attribute to those objects, this set can be applied by the filter module to determine which objects to display. In one embodiment, the set of objects is stored in memory as a list of object identifiers. This enables quick access to the set of related objects, and thus can improve performance of the stadium view visualization. In another embodiment, part or all of the set of related objects is stored by storing a database query that, when executed, will return those objects. This reduces the number of object identifiers that are stored in memory, which can improve performance of the stadium view visualization if the number of objects in the set is sufficiently large for the memory requirements of storing the whole set to be prejudicial to system performance. In further embodiments, other methods for storing the set of objects are used.

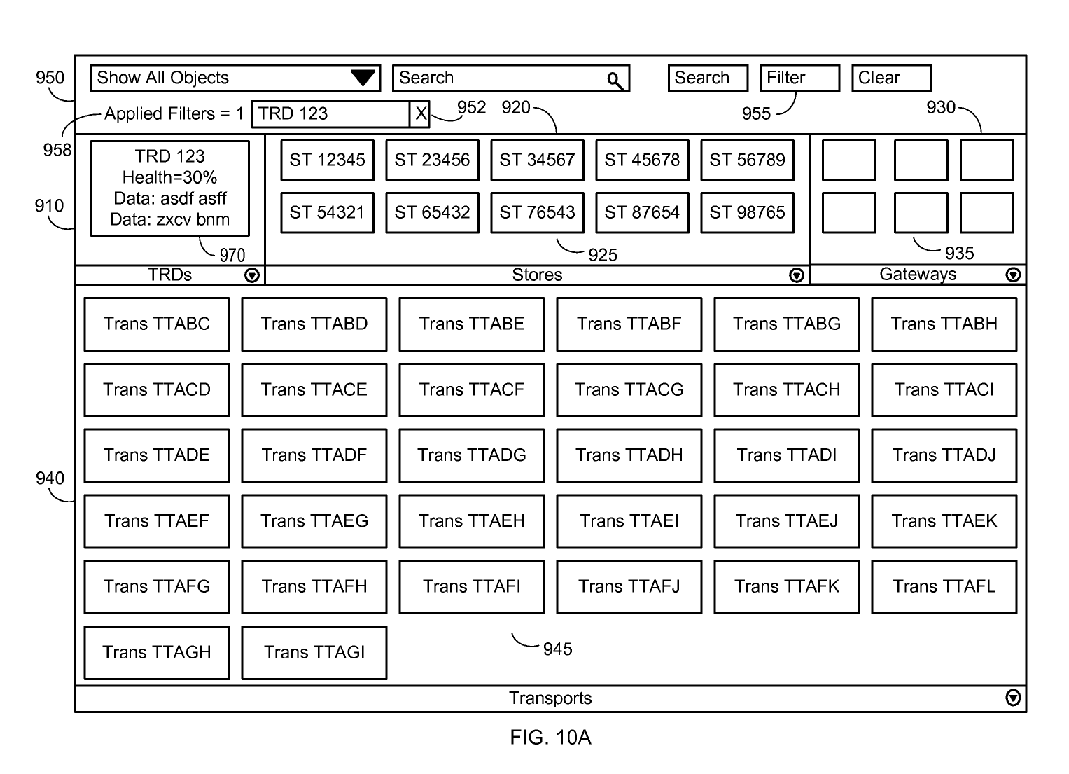

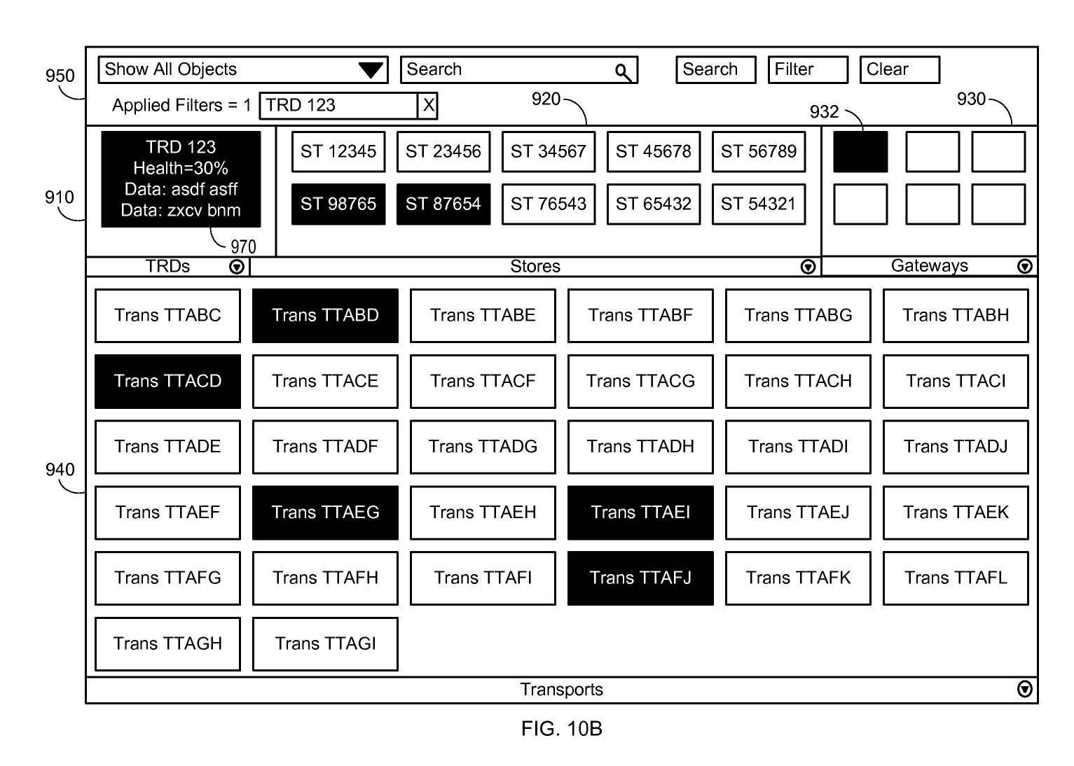

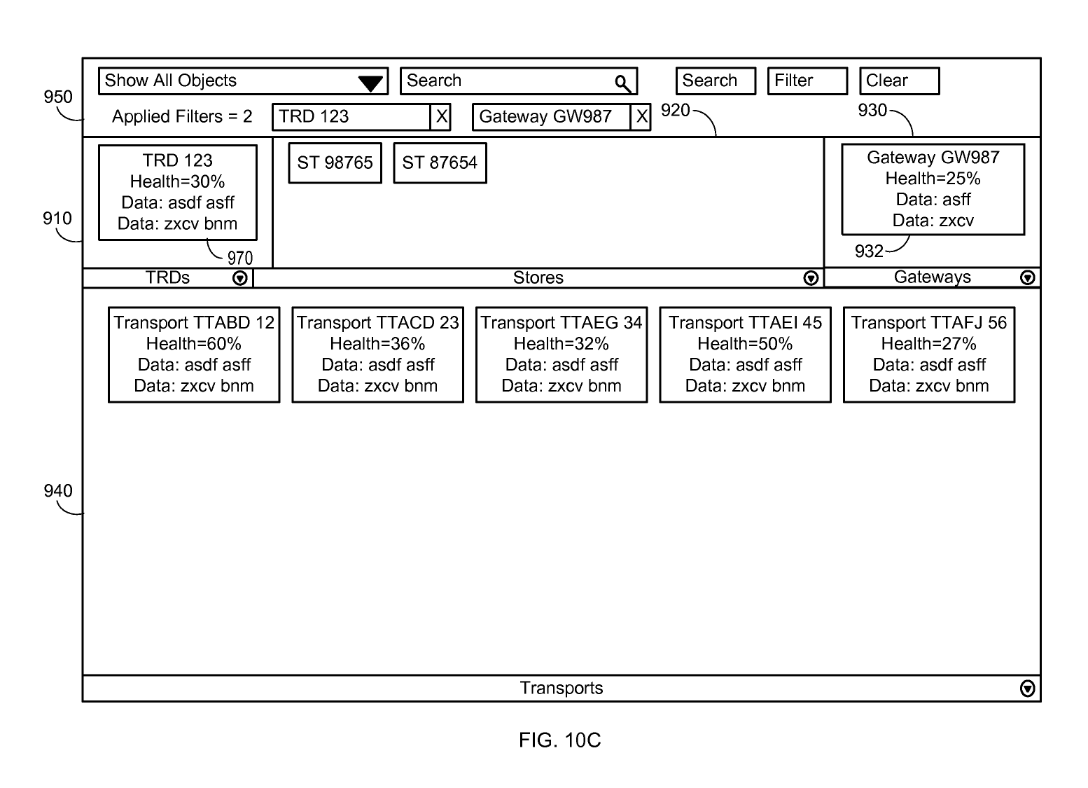

At 530, the visualization engine 210 updates the plurality of frames (910, 920, 930, and 940) to display just the objects that meet the applied filter. FIG. 10A illustrates how the stadium view visualization shown in FIG. 9C is updated in response the user applying a filter to display just those objects that are related to the selected TRD object 970, in accordance with one embodiment. The filter counter 958 in the toolbar 950 maintains a count of the number of filters being used, here indicating that a single filter has been applied, and a visual representation 952 that indicates the element being filtered on (here, the selected TRD object 970). In this embodiment, the user may remove the filter by clicking on the X included in the filter's representation 952 in the toolbar 950. Each of the frames (910, 920, 930, and 940) is updated such that only those objects that pass the filter (e.g., those that are related to the selected element) are represented. In this case, ten store objects 925 are shown in FIG. 10A, because, as can be seen in FIG. 9C, ten stores are related to the selected TRD. In the same way, six gateway objects 935 are represented as well as thirty-two transport objects 945. Note that as fewer objects are included in the frames (910, 920, 930, and 940) the visualization module 210 expands the size of each remaining object, enabling additional information about the corresponding elements to be displayed.

As described previously, filters and requests to view related objects can be applied to the stadium view visualization iteratively. FIG. 10B illustrates the result of the user requesting to see all objects that are related to one of the gateways, after the filter based on the selected TRD has been applied. FIG. 10C illustrates the result of the user then applying a second filter, based on the selected gateway object 932. Note that the toolbar 950 is updated to indicate that two filters are now applied, and the number of objects represented in each frame (910, 920, 930, and 940) is reduced further. Thus, with just two intuitive filter steps, the user has narrowed the search for a particular element from over a thousand candidates (in FIG. 9C) to just nine (in FIG. 10C).

FIG. 6 illustrates an exemplary method of filtering the displayed objects in the stadium view visualization based on corresponding element states. In one embodiment, each object is determined to be in one of four operational states: major issues, medium issues, minor issues, and no issues. The steps of FIG. 5 are illustrated from the perspective of various components of the administrator system 160 performing the method. However, some or all of the steps may be performed by other entities and/or components. In addition, some embodiments may perform the steps in parallel, perform the steps in different orders, or perform different steps.

At 610, the visualization engine 210 displays a plurality of frames (910, 920, 930, and 940). Each frame is associated with a type of element in the network, and includes a plurality of objects 960 of the corresponding type. At 620, the administrator system 160 receives a request to highlight objects based on the state of the corresponding element. Typically the request is generated by user input, but it may also be the result of an automated process that is triggered by the user's interaction with the stadium view visualization. FIG. 11A shows one embodiment of the stadium view visualization in which the toolbar 950 includes a drop down menu 954 that enables the user to request various views, including highlighting objects corresponding to elements with issues.

Referring again to FIG. 6, at 630, the visualization engine updates the stadium view visualization to visually indicate which of a plurality of states the element corresponding to each object is in. In the example of the networked environment 100, the states are issue states, indicating the seriousness of problems that the elements are reporting, or lack thereof. In other implementations, other states can be indicated, depending on the nature of the data set being visualized. For example, if the data set is a social network, the states may be different categories of relationship, such as family, friends, and acquaintances. FIG. 1 lB illustrates how the visualization shown in FIG. 11A is modified in response to the request to highlight objects in the networked environment 100 by state. Objects corresponding to elements with major issues 962 are visually distinguished in one way (in this case, by being filled with black), objects with medium issues 964 are visually distinguished in another way (in this case, by adding diagonal lines running from top-left to bottom-right), and objects with minor issues 966 are visually distinguished in a third way (in this case, with diagonal lines running from bottom-left to top-right), while objects with no issues 968 remain visually unchanged. Notice that in FIG. 11B, the objects are also sorted by issue status, with the objects with major issues 962 displayed first, followed by those with medium issues 964, etc. However, in other embodiments, the objects remain in their initial positions and are just distinguished visually.

Referring back to FIG. 6, at 640, the administrator system 160 receives a request to filter the objects by at least one of the states. For example, in the case of the networked environment 100, the user may wish to view only those objects that correspond to elements that have major issues 962. Thus, the user can use the toolbar 950 to apply a filter that removes all objects that do not meet the required criteria.

At 650, the visualization engine 210 updates the plurality of frames (910, 920, 930, and 940) to display just objects that pass the applied filter, namely those objects that correspond to elements in the selected state. FIG. 11C illustrates how the stadium view visualization is updated in response to the user requesting to view only objects corresponding to elements with major issues 962. In this case, the user does this by selecting the corresponding option 957 from then drop down menu 954 in the toolbar 950. As a result, only those objects corresponding to elements with major issues 962 are displayed, making more room in the stadium view visualization to provide information about each displayed object, and assisting the user in diagnosing the problem.

FIG. 7 illustrates an exemplary method of providing a visual indication of objects that are related to a topic, according to one embodiment. The steps of FIG. 7 are illustrated from the perspective of various components of the administrator system 160 performing the method. However, some or all of the steps may be performed by other entities and/or components. In addition, some embodiments may perform the steps in parallel, perform the steps in different orders, or perform different steps.

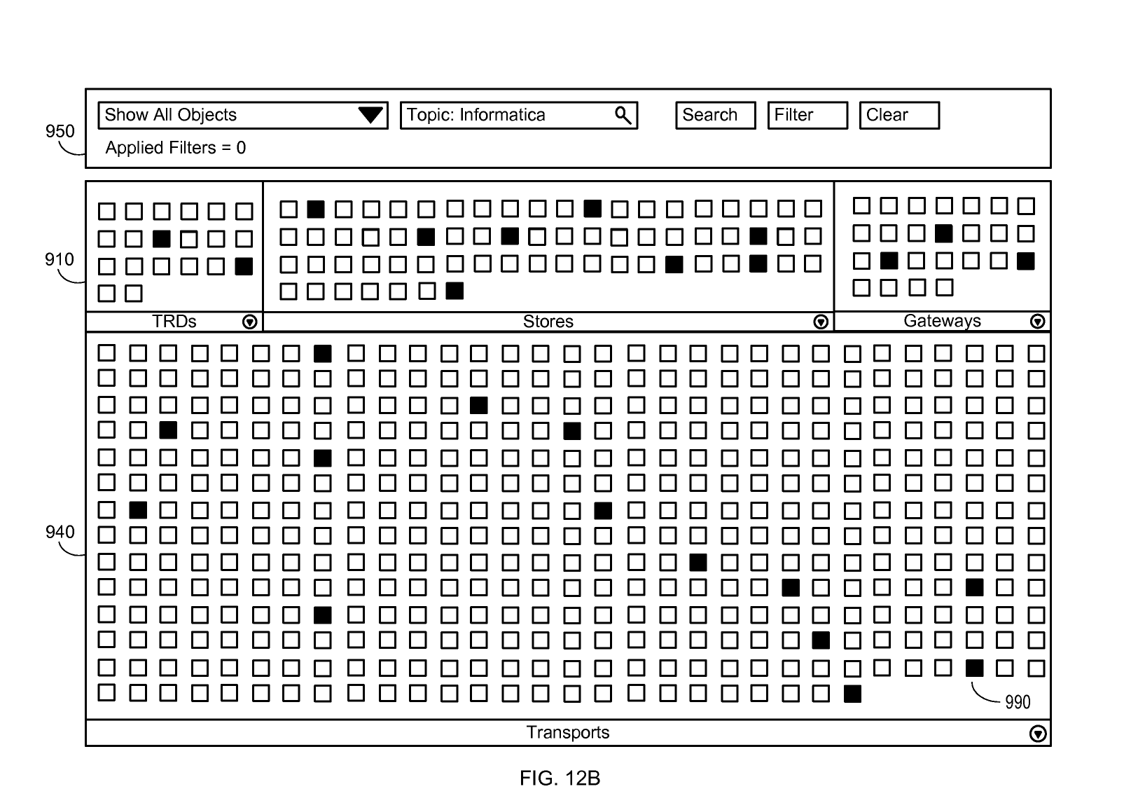

At 710, the visualization engine 210 displays a plurality of frames (910, 920, 930, and 940). Each frame is associated with a type of element in the network, and includes a plurality of objects 960 of the corresponding type. At 720, the administrator system 160 receives a topic name that is to be used as a search parameter. For example, the user may type a topic name into a field 951 in the toolbar 950 and press a corresponding search button 953. FIG. 12A illustrates the stadium view visualization of the networked environment 100 in a state where it is displaying all of the available objects 960. The user has entered the search term “Topic: Informatica” in the field 951 but is yet to press the search button 953.

Referring back to FIG. 7, at 730, the search module 240 identifies elements that are related to the search topic. In the example illustrated by FIGS. 12A and 12B, the input search topic is “Informatica.” Thus, all elements in the network environment 100 that contribute to the delivery of Informatica messages are identified as related to the search topic. For example, if an Informatica message is sent from a first host within a first TRD to a second host within a second TRD, the search will return both hosts and TRDs as being related to Informatica messages. The search may also return a store within which the message was persisted prior to delivery, a gateway that connects the two TRDs, several transports used for delivery of the message, and an application from which the message originated. In one embodiment, the administrator system 160 maintains a database in local storage 260 that includes mappings between topics and the various elements of the network 150. For example, the database might include a record for each topic and a list of identifiers of elements that are related to that topic. Alternatively or additionally, the database might include a record for each element indicating the topics to which that element is related.

At 740, the visualization engine 210 updates the stadium view visualization to visually distinguish the objects that correspond to elements identified by the search. FIG. 12B illustrates how the visualization engine 210 updates the stadium view visualization in response to the user searching for the topic “Informatica,” in accordance with one embodiment. Note that a plurality of each type of object have been visually highlighted (e.g., transport object 990), in this case by adding a black fill to the objects. In other embodiments, other manners of visual distinction are used.

By visually distinguishing the objects that are related to the elements identified by the search, the stadium view visualization enables the user to quickly identify which elements relate to that search term. Thus, if a network manager knows that end users are experiencing issues with functionality related to a specific topic, the network manager can search for that topic and quickly generate a shortlist of elements that may be responsible for the problem. Although not shown in the figures, the results of a search can also be applied as a filter.

The systems and methods described above for implementing and using a stadium view visualization provide an intuitive way for a user to explore a network of elements with complex, multi-layered, and/or regularly changing relationships. In various embodiments, the user can cause the objects corresponding to related elements to be visually distinguished from other objects, search for elements with particular properties, and identify the status of elements, as well as apply filters based on one or more properties. By using visual distinctions, the use of lines to indicate relationships between objects is obviated, leading to a clearer, more user-friendly representation of the network.

### Additional Configuration Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for providing a visualization of relationships in a network of elements. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

1. A user interface of a computer system configured to display a visualization of a large data set of inter-related elements, each element having a type among a plurality of types, the user interface comprising:
a frames portion, comprising:
a plurality of regularly shaped, non-overlapping graphical objects, each object representing an instance of an element in the data set; and
a plurality of frames, each frame corresponding to one type of the plurality of types of element, and containing objects representing elements of the same type, such that a first frame contains only objects representing elements of a first type, and a second frame contains only objects representing elements of a second type, where, in each frame, the objects are displayed in a regular arrangement, not overlapping with each other, and without any lines connecting between any of the objects within a frame;
the frames portion configured to receive a selection of an object in the first frame that represents a first element of the first type, and to update, in the second frame, a visual attribute of those objects representing elements of the second type having at least one predetermined relationship with the first element to be different from a corresponding attribute of objects in the second frame that do not have the at least one predetermined relationship with the first element.

2. The user interface of claim 1, further comprising:
a toolbar portion, comprising:
a filter control for applying a filter to the plurality of objects, the frames portion configured to update the first frame, in response to applying the filter, such that the first frame displays only those objects that represent elements of the first type that meet the filter; and
an applied filters portion comprising an indication of filters currently applied.

3. The user interface of claim 2, wherein the frames portion is further configured to update the second frame, in response to application of the filter, such that the second frame displays only those objects that represent elements of the second type that meet the filter.

4. The user interface of claim 1, wherein the visual attribute that is updated is selected from a group consisting of: color, brightness level, outline style, size, and fill texture.

5. The user interface of claim 1, wherein the plurality of frames comprises at least two frames from the group consisting of: a topic resolution domain frame, a store frame, a gateway frame, a transport frame, a host frame, and an application instance frame.

6. The user interface of claim 1, wherein the toolbar portion further comprises a search control, the search control configured to obtain a search topic via user input, the frames portion further configured to update a visual attribute of those objects representing elements related to the search topic.

7. The user interface of claim 1, wherein the frames portion is further configured to set a second visual attribute of objects representing elements in a first operational state to a first value and set the second visual attribute of objects representing elements in a second operational state to a second value.

8. A method of visualizing a large data set of inter-related elements of a plurality of types, the method comprising:
providing for display a frames portion comprising:
a plurality of regularly shaped, non-overlapping graphical objects, each object representing an instance of an element in the data set; and
a plurality of frames, each frame corresponding to one type of the plurality of types of element, and containing objects representing elements of the same type, such that a first frame contains only objects representing elements of a first type, and a second frame contains only objects representing elements of a second type, where, in each frame, the objects are displayed in a regular arrangement, not overlapping with each other, and without any lines connecting between any of the objects within a frame;
receiving an indication of a selected element represented by one of the plurality of objects;
retrieving stored relationship data for the selected element;
updating, in the second frame, a visual attribute of those objects representing elements of the second type having at least one predetermined relationship with the first element to be different from a corresponding attribute of objects in the second frame that do not have the at least one predetermined relationship with the first element.

9. The method of claim 8, further comprising:
providing for display a toolbar portion comprising:
a filter control for applying a filter to the plurality of objects; and
an applied filters portion comprising an indication of filters currently applied; and
updating the first frame, in response to applying the filter, such that the first frame displays only those objects that represent elements of the first type that meet the filter.

10. The method of claim 9, further comprising:
updating the second frame, in response to application of the filter, such that the second frame displays only those objects that represent elements of the second type that meet the filter.

11. The method of claim 8, wherein the visual attribute that is updated is selected from a group consisting of: color, brightness level, outline style, size, and fill texture.

12. The method of claim 8, wherein the plurality of frames comprises at least two frames from the group consisting of: a topic resolution domain frame, a store frame, a gateway frame, a transport frame, a host frame, and an application instance frame.

13. The method of claim 8, further comprising:
obtaining a search topic via user input; and
updating a visual attribute of those objects representing elements related to the search topic.

14. The method of claim 8, further comprising:
setting a second visual attribute of objects representing elements in a first operational state to a first value; and
setting the second visual attribute of objects representing elements in a second operational state to a second value.

15. A non-transitory computer-readable storage medium having computer program instructions embodied therein for visualizing a large data set of inter-related elements of a plurality of types, the computer program instructions comprising instructions for:
providing for display a frames portion comprising:
a plurality of regularly shaped, non-overlapping graphical objects, each object representing an instance of an element in the data set; and
a plurality of frames, each frame corresponding to one type of the plurality of types of element, and containing objects representing elements of the same type, such that a first frame contains only objects representing elements of a first type, and a second frame contains only objects representing elements of a second type, where, in each frame, the objects are displayed in a regular arrangement, not overlapping with each other, and without any lines connecting between any of the objects within a frame;
receiving an indication of a selected element represented by one of the plurality of objects;
retrieving stored relationship data for the selected element;
updating, in the second frame, a visual attribute of those objects representing elements of the second type having at least one predetermined relationship with the first element to be different from a corresponding attribute of objects in the second frame that do not have the at least one predetermined relationship with the first element.

16. The non-transitory computer readable storage medium of claim 15, wherein the computer program instructions further comprise instructions for:
providing for display a toolbar portion comprising:
a filter control for applying a filter to the plurality of objects; and
an applied filters portion comprising an indication of filters currently applied;
updating the first frame, in response to applying the filter, such that the first frame displays only those objects that represent elements of the first type that meet the filter; and
updating the second frame, in response to application of the filter, such that the second frame displays only those objects that represent elements of the second type that meet the filter.

17. The non-transitory computer readable storage medium of claim 15, wherein the computer program instructions further comprise instructions for:
obtaining a search topic via user input; and
updating a visual attribute of those objects representing elements related to the search topic.

18. The non-transitory computer readable storage medium of claim 15, wherein the computer program instructions further comprise instructions for:
setting a second visual attribute of objects representing elements in a first operational state to a first value; and
setting the second visual attribute of objects representing elements in a second operational state to a second value.

19. A user interface of a computer system configured to display a visualization of a computer network comprising a large number of elements, each element having a type among a plurality of types, the user interface comprising:
a frames portion, comprising:
a plurality of regularly shaped, non-overlapping graphical objects, each object representing an instance of an element in the network; and
a plurality of frames, each frame corresponding to one type of the plurality of types of element, and containing objects representing elements of the same type, such that a first frame contains only objects representing elements of a first type, and a second frame contains only objects representing elements of a second type, where, in each frame, the objects are displayed in a regular arrangement, not overlapping with each other, and without any lines connecting between any of the objects within a frame;
the frames portion configured to receive a selection of an object in the first frame that represents a first element of the first type, and to update, in the second frame, a visual attribute of those objects representing elements of the second type having at least one predetermined relationship with the first element to be different from a corresponding attribute of objects in the second frame that do not have the at least one predetermined relationship with the first element.

20. The user interface of claim 19, wherein the types include at least one type selected from a group consisting of: topic resolution domains, stores, gateways, transports, hosts, and application instances.
